(19) United States
(12) Patent Application Publication
(10) Pub. No.: US 2015/0122409 A1
(43) Pub. Date: May 7, 2015

(54) PROCESS FOR APPLYING TRANSFER COATINGS TO SUBSTRATES

(71) Applicant: PPG Industries Ohio, Inc., Cleveland, OH (US)

(72) Inventor: Todd M. Roper, Katy, TX (US)

(73) Assignee: PPG Industries Ohio, Inc., Cleveland, OH (US)

(21) Appl. No.: 14/072,078

(22) Filed: Nov. 5, 2013

(51) Int. Cl. B05D 5/06; B05D 1/36; B05D 3/10; B05D 1/28

(52) U.S. Cl. CPC B05D 5/066; B05D 1/286; B05D 1/36; B05D 5/061; B05D 3/108
USPC 156/230

(57) ABSTRACT

The present invention is directed to various processes for applying a coating composition to a substrate such as an exterior automotive substrate, comprising:
(a) contacting the coating composition, which has been deposited on a carrier film, with the substrate such that the coating composition is in direct contact with the automotive substrate; and
(b) removing the carrier film from the coating composition.

The substrate may have a primer coating layer and/or a pigmented base coat or monocoat layer applied prior to the coating composition. The process of the present invention may be used for applying a two-tone, multi-component coating composition to a substrate.

### FIELD OF THE INVENTION

The present invention relates to processes for applying transfer coatings to substrates.

### BACKGROUND OF THE INVENTION

Color-plus-clear coating systems that include a colored or pigmented base coat applied to a substrate followed by a transparent or clear topcoat applied on top of the base coat have long been the standard as original finishes for automobiles. The color-plus-clear systems have excellent aesthetic properties such as outstanding gloss and distinctness of image.

Two-tone color patterns are also popular as desirable aesthetic effects on vehicles. Conventional two-tone painting involves the application of a base coat and clear coat system to an entire automotive part or portion thereof, after which an area is covered or “masked” so that the remaining exposed area can be painted with a different colored base coat followed by a clear coat. The masking process can be very labor intensive, and removal of unwanted overspray of secondary colors on areas that were not masked properly can be difficult.

It would be desirable to provide a simple, straightforward method of two-tone painting using transfer coatings.

### SUMMARY OF THE INVENTION

The present invention is directed to a process for applying a coating composition to an exterior automotive substrate comprising:

(a) contacting the coating composition, which has been deposited on a carrier film, with the automotive substrate such that the coating composition is in direct contact with the automotive substrate; and

(b) removing the carrier film from the coating composition.

The present invention further provides a process for applying a transfer coating to a substrate comprising:

(a) contacting the transfer coating, which has been deposited on a carrier film, with the substrate such that the transfer coating is in direct contact with the substrate; and

(b) removing the carrier film from the transfer coating;

wherein the transfer coating is opaque.

The present invention additionally provides a process for applying a two-tone, multi-component coating composition to a substrate comprising:

(a) optionally applying a primer coating layer to the substrate;

(b) applying a first pigmented base coat or monocoat layer having a first color to the primer coating layer or substrate;

(c) contacting with the substrate a transfer coating that has a second, different color and that has been deposited on a carrier film, such that the transfer coating is in direct contact with the first pigmented base coat or monocoat layer; and

(d) removing the carrier film from the transfer coating.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used in the following description and claims, the following terms have the meanings indicated below:

By “polymer” is meant a polymer including homopolymers and copolymers, and oligomers. By “composite material” is meant a combination of two or more differing materials.

The term “curable”, as used for example in connection with a curable composition, means that the indicated composition is polymerizable or cross linkable through functional groups, e.g., by means that include, but are not limited to, thermal (including ambient cure), catalytic, electron beam, chemical free-radical initiation, and/or photo-initiation such as by exposure to ultraviolet light or other actinic radiation.

The term “cure”, “cured” or similar terms, as used in connection with a cured or curable composition, a “cured composition” of some specific description, means that at least a portion of the polymerizable and/or crosslinkable components that form the curable composition is polymerized and/or crosslinked. Additionally, curing of a polymerizable composition refers to subjecting said composition to curing conditions such as but not limited to thermal curing, leading to the reaction of the reactive functional groups of the composition, and resulting in polymerization and formation of a polymerizate. When a polymerizable composition is subjected to curing conditions, following polymerization and after reaction of most of the reactive groups occurs, the rate of reaction of the remaining unreacted reactive groups becomes progressively slower. The polymerizable composition can be subjected to curing conditions until it is at least partially cured. The term “at least partially cured” means subjecting the polymerizable composition to curing conditions, wherein reaction of at least a portion of the reactive groups of the composition occurs, to form a polymerizate. The polymerizable composition can also be subjected to curing conditions such that a substantially complete cure is attained and wherein further curing results are no significant further improvement in polymer properties, such as hardness.

The term “reactive” refers to a functional group capable of undergoing a chemical reaction with itself and/or other functional groups spontaneously or upon the application of heat or in the presence of a catalyst or by any other means known to those skilled in the art.

By “essentially free” of a material is meant that a composition has only trace or incidental amounts of a given material, and that the material is not present in an amount sufficient to affect any properties of the composition.

The present invention provides processes for applying coating compositions to substrates. These substrates are often called “target substrates”, to distinguish them from the carrier films on which the coating compositions are deposited and carried prior to the process. Suitable substrates include metal substrates such as ferrous metals, zinc, copper, magnesium, aluminum, aluminum alloys, and other metal and alloy substrates typically used in the manufacture of automobile and other vehicle bodies. The ferrous metal substrates may include iron, steel, and alloys thereof. Non-limiting examples of useful steel materials include cold rolled steel, galvanized (zinc coated) steel, electrogalvanized steel, stainless steel, pickled steel, zinc-iron ahoy such as GALVANNEAL, and combinations thereof. Combinations or composites of ferrous and non-ferrous metals can also be used.

Elastomeric or plastic substrates such as those that are found on motor vehicles are also suitable for the processes of the present invention. By “plastic” is meant any of the common thermoplastic or thermosetting synthetic nonconductive materials, including thermoplastic olefins such as polyethylene and polypropylene, thermoplastic urethane, polycarbonate, thermosetting sheet molding compound, reaction-injection molding compound, acrylonitrile-based materials, nylon, and the like.

The substrates are most often metal or plastic exterior automotive substrates; in particular, automotive body parts such as hoods, lids, fenders, door panels, roofs, bumpers, and the like.

Before depositing any treatment or coating compositions upon the surface of the substrate, it is common practice, though not necessary, to remove foreign matter from the surface by thoroughly cleaning and degreasing the surface. Such cleaning typically takes place after forming the substrate (stamping, welding, etc.) into an end-use shape. The surface of the substrate can be cleaned by physical or chemical means, such as mechanically abrading the surface or cleaning/degreasing with commercially available alkaline or acidic cleaning agents that are well known to those skilled in the art, such as sodium metasilicate and sodium hydroxide. A non-limiting example of a cleaning agent is CHEMKLEEN 163, an alkaline-based cleaner commercially available from PPG Industries, Inc.

Following the cleaning step, the substrate may be rinsed with deionized water or an aqueous solution of rinsing agents in order to remove any residue. The substrate can be air dried, for example, by using an air knife, by flashing off the water by brief exposure of the substrate to a high temperature or by passing the substrate between squeegee rolls.

The substrate to which the coating composition is applied may be a bare, cleaned surface; it may be oily, pretreated with one or more pretreatment compositions, and/or prepainted with one or more coating compositions, primers, etc., applied by any method including, but not limited to, electrodeposition, spraying, dip coating, roll coating, curtain coating, and the like.

In certain embodiments of the present invention, particularly when the substrate is an automotive body part, the substrate may further comprise a primer coating layer applied on the surface of the substrate. The primer coating layer may comprise any primer composition known in the art; in an automotive application, the primer is typically a curable composition. The primer can comprise a resinous binder and a pigment and/or other colorant, as well as optional additives well known in the art of coating compositions. Nonlimiting examples of resinous binders are acrylic polymers, polyesters, alkyds, and polyurethanes. The coating composition may be applied directly from the carrier film to the primer coating layer.

In particular embodiments, the primer coating layer may comprise a curable composition applied on the surface of the substrate and partially cured prior to application of the coating composition. When the coating composition is a curable composition and is applied directly to the primer coating layer on the substrate, a curing step may be performed prior to or after removal of the carrier film, wherein the automotive substrate is subjected to conditions sufficient to cure the primer coating layer and the coating composition. In such embodiments, the primer coating layer may comprise components having functional groups that are reactive with functional groups on components in the coating composition, improving intercoat adhesion.

In alternative embodiments of the present invention, particularly when the substrate is an automotive body part, the substrate may further comprise a primer coating layer applied on the surface of the substrate, and/or a pigmented base coat or monocoat layer having a first color applied thereto. The coating composition may have a second, different color and is applied directly from the carrier film to the base coat or monocoat layer. This process is particularly useful for the application of two-tone, multi-component composite coating compositions to a substrate.

Suitable base coat or monocoat compositions include any known in the art, and may be any of those described below with respect to the coating composition on the carrier film. In automotive applications the base coat or monocoat compositions are typically curable compositions. The basecoat or monocoat can comprise a resinous binder and a pigment and/or other colorant, as well as optional additives well known in the art of coating compositions. Nonlimiting examples of resinous binders are acrylic polymers, polyesters, alkyds, and polyurethanes, in combination with any of various crosslinking agents known in the art.

In particular embodiments, the base coat or monocoat layer may comprise a curable composition applied on the surface of the substrate and at least partially cured prior to application of the coating composition. When the coating composition on the carrier film is a curable composition and is applied directly to the base coat or monocoat layer on the substrate, a curing step may be performed prior to or after removal of the carrier film, wherein the automotive substrate is subjected to conditions sufficient to cure the base coat or monocoat layer and the coating composition. In such embodiments, the base coat or monocoat layer may comprise components having functional groups that are reactive with functional groups on components in the coating composition, improving intercoat adhesion.

The coating compositions that are deposited on the carrier film used in the processes of the present invention comprise one or more film-forming resins. The compositions may be lacquers or curable compositions. Curable compositions may further comprise a crosslinking agent.

Particularly useful polymeric film-forming resins are acrylic polymers, polyesters, including alkyds, and polyurethanes. Generally these polymers can be any polymers of these types made by any method known to those skilled in the art where the polymers are water dispersible or emulsifiable and preferably of limited water solubility.

Suitable acrylic polymers include copolymers of one or more alkyl esters of acrylic acid or methacrylic acid, optionally together with one or more other polymerizable ethylenically unsaturated monomers having one or more ethylenically unsaturated groups. Useful alkyl esters of acrylic acid or methacrylic acid include aliphatic alkyl esters containing from 1 to 30, and preferably 4 to 18 carbon atoms in the alkyl group. Non-limiting examples include methyl methacrylate, ethyl methacrylate, butyl methacrylate, ethyl acrylate, butyl acrylate, ethylene glycol dimethacrylate, and 2-ethyl hexyl acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

The acrylic copolymer can include hydroxyl functional groups, which are often incorporated into the polymer by including one or more hydroxyl functional monomers in the reactants used to produce the copolymer. Useful hydroxyl functional monomers include hydroxyalkyl acrylates and methacrylates, typically having 2 to 4 carbon atoms in the hydroxyalkyl group, such as hydroxyethyl acrylate, hydroxypropylacrylate, 4-hydroxybutyl acrylate, hydroxy functional adducts of caprolactone and hydroxyalkyl acrylates, and corresponding methacrylates, as well as the beta-hydroxy ester functional monomers described below. The acrylic polymer can also be prepared with N-(alkoxymethyl)acrylamides and N-(alkoxymethyl)methacrylamides.

Beta-hydroxy ester functional monomers can be prepared from ethylenically unsaturated, epoxy functional monomers and carboxylic acids having from about 13 to about 20 carbon atoms, or from ethylenically unsaturated acid functional monomers and epoxy compounds containing at least 5 carbon atoms which are not polymerizable with the ethylenically unsaturated acid functional monomer.

Useful ethylenically unsaturated, epoxy functional monomers used to prepare the beta-hydroxy ester functional monomers include, but are not limited to, glycidyl acrylate, glycidyl methacrylate, allyl glycidyl ether, methallyl glycidyl ether, 1:1 (molar) adducts of ethylenically unsaturated monoisocyanates with hydroxy functional monoepoxides such as glycidol, and glycidyl esters of polymerizable polycarboxylic acids such as maleic acid. Glycidyl acrylate and glycidyl methacrylate are preferred. Examples of carboxylic acids include, but are not limited to, saturated monocarboxylic acids such as isostearic acid and aromatic unsaturated carboxylic acids.

Useful ethylenically unsaturated acid functional monomers used to prepare the beta-hydroxy ester functional monomers include monocarboxylic acids such as acrylic acid, methacrylic acid, crotonic acid; dicarboxylic acids such as itaconic acid, maleic acid and fumaric acid, and monoesters of dicarboxylic acids such as monobutyl maleate and monobutyl itaconate. The ethylenically unsaturated acid functional monomer and epoxy compound are typically reacted in a 1:1 equivalent ratio. The epoxy compound does not contain ethylenic unsaturation that would participate in free radical-initiated polymerization with the unsaturated acid functional monomer. Useful epoxy compounds include 1,2-pentene oxide, styrene oxide and glycidyl esters or ethers, preferably containing from 8 to 30 carbon atoms, such as butyl glycidyl ether, octyl glycidyl ether, phenyl glycidyl ether and para-(tertiary butyl) phenyl glycidyl ether. Preferred glycidyl esters include those of the structure:

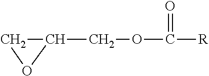

where R is a hydrocarbon radical containing from about 4 to about 26 carbon atoms. Preferably, R is a branched hydrocarbon group having from about 8 to about 10 carbon atoms, such as neopentanoate, neoheptanoate or neodecanoate. Suitable glycidyl esters of carboxylic acids include VERSATIC ACID 911 and CARDURA E, each of which are commercially available from Shell Chemical Co.

Carbamate functional groups can be included in the acrylic polymer by copolymerizing the acrylic monomers with a carbamate functional vinyl monomer, such as a carbamate functional alkyl ester of methacrylic acid, or by reacting a hydroxyl functional acrylic polymer with a low molecular weight carbamate functional material, such as can be derived from an alcohol or glycol ether, via a transcarbamoylation reaction. Alternatively, carbamate functionality may be introduced into the acrylic polymer by reacting a hydroxyl functional acrylic polymer with a low molecular weight carbamate functional material, such as can be derived from an alcohol or glycol ether, via a transcarbamoylation reaction. In this reaction, a low molecular weight carbamate functional material derived from an alcohol or glycol ether is reacted with the hydroxyl groups of the acrylic polyol, yielding a carbamate functional acrylic polymer and the original alcohol or glycol ether. The low molecular weight carbamate functional material derived from an alcohol or glycol ether may be prepared by reacting the alcohol or glycol ether with urea in the presence of a catalyst. Suitable alcohols include lower molecular weight aliphatic, cycloaliphatic, and aromatic alcohols such as methanol, ethanol, propanol, butanol, cyclohexanol, 2-ethylhexanol, and 3-methylbutanol. Suitable glycol ethers include ethylene glycol methyl ether and propylene glycol methyl ether. Propylene glycol methyl ether and methanol are most often used. Other useful carbamate functional monomers are disclosed in U.S. Pat. No. 5,098,947, which is incorporated herein by reference. Other useful carbamate functional monomers are disclosed in U.S. Pat. No. 5,098,947, which is incorporated herein by reference.

Amide functionality may be introduced to the acrylic polymer by using suitably functional monomers in the preparation of the polymer, or by converting other functional groups to amido-groups using techniques known to those skilled in the art. Likewise, other functional groups may be incorporated as desired using suitably functional monomers if available or conversion reactions as necessary.

Acrylic polymers can be prepared via aqueous emulsion polymerization techniques and used directly in the preparation of the aqueous coating compositions, or can be prepared via organic solution polymerization techniques with groups capable of salt formation such as acid or amine groups. Upon neutralization of these groups with a base or acid the polymers can be dispersed into aqueous medium. Generally any method of producing such polymers that is known to those skilled in the art utilizing art recognized amounts of monomers can be used.

It is also possible to use a radiation curable coating composition, comprising ethylenically unsaturated monomers including any of those disclosed above and combinations thereof.

Besides acrylic polymers, the polymeric film-forming resin in the coating composition may be an alkyd resin or a polyester. Such polymers may be prepared in a known manner by condensation of polyhydric alcohols and polycarboxylic acids. Suitable polyhydric alcohols include, but are not limited to, ethylene glycol, propylene glycol, butylene glycol, 1,6-hexylene glycol, neopentyl glycol, diethylene glycol, glycerol, trimethylol propane, and pentaerythritol. Suitable polycarboxylic acids include, but are not limited to, succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used.

Useful alkyd resins include polyesters of polyhydroxyl alcohols and polycarboxylic acids chemically combined with various drying, semi-drying and non-drying oils in different proportions. Thus, for example, the alkyd resins are made from polycarboxylic acids such as phthalic acid, maleic acid, fumaric acid, isophthalic acid, succinic acid, adipic acid, azeleic acid, sebacic acid as well as from anhydrides of such acids, where they exist. The polyhydric alcohols which can be reacted with the polycarboxylic acid include 1,4-butanediol, hexanediol, neopentyl glycol, ethylene glycol, diethylene glycol and 2,3-butylene glycol, glycerol, trimethylolpropane, pentaerythritol, sorbitol and mannitol.

The alkyd resins are produced by reacting the polycarboxylic acid and the polyhydric alcohol together with a drying, semi-drying or non-drying oil in proportions depending upon the properties desired. The oils are coupled into the resin molecule by esterification during manufacturing and become an integral part of the polymer. The oil is fully saturated or predominately unsaturated. When cast into films, fully saturated oils tend to give a plasticizing effect to the film, whereas predominately unsaturated oils tend to crosslink and dry rapidly with oxidation to give more tough and solvent resistant films. Suitable oils include coconut oil, fish oil, linseed oil, tung oil, castor oil, cottonseed oil, safflower oil, soybean oil, and tall oil. Various proportions of the polycarboxylic acid, polyhydric alcohol and oil are used to obtain alkyd resins of various properties as is well known in the art.

Carbamate functional groups may be incorporated into the polyester by first forming a hydroxyalkyl carbamate which can be reacted with the polyacids and polyols used in forming the polyester. The hydroxyalkyl carbamate is condensed with acid functionality on the polyester, yielding terminal carbamate functionaiity. Carbamate functional groups may also be incorporated into the polyester by reacting terminal hydroxyl groups on the polyester with a low molecular weight carbamate functional material via a transcarbamoylation process similar to the one described above in connection with the incorporation of carbamate groups into the acrylic polymers, or by reacting isocyanic acid with a hydroxyl functional polyester.

Other functional groups such as amide, thiol, urea, and thiocarbamate may be incorporated into the polyester or alkyd resin as desired using suitably functional reactants if available, or conversion reactions as necessary to yield the desired functional groups. Such techniques are known to those skilled in the art.

Polyurethanes can also be used in the coating composition. Among the polyurethanes which can be used are polymeric polyols which generally are prepared by reacting the polyester polyols or acrylic polyols such as those mentioned above with a polyisocyanate such that the OH/NCO equivalent ratio is greater than 1:1 so that free hydroxyl groups are present in the product. The organic polyisocyanate which is used to prepare the polyurethane polyol can be an aliphatic or an aromatic polyisocyanate or a mixture of the two. Diisocyanates are preferred, although higher polyisocyanates can be used in place of or in combination with diisocyanates. Examples of suitable aromatic diisocyanates are 4,4′-diphenylmethane diisocyanate and toluene diisocyanate. Examples of suitable aliphatic diisocyanates are straight chain aliphatic diisocyanates such as 1,6-hexamethylene diisocyanate. Also, cycloaliphatic diisocyanates can be employed. Examples include isophorone diisocyanate and 4,4′-methylene-bis-(cyclohexyl isocyanate). Examples of suitable higher polyisocyanates are 1,2,4-benzene triisocyanate and polymethylene polyphenyl isocyanate. As with the polyesters, the polyurethanes can be prepared with unreacted carboxylic acid groups, which upon neutralization with bases such as amines allows for dispersion into aqueous medium.

Terminal and/or pendent carbamate functional groups can be incorporated into the polyurethane by reacting a polyisocyanate with a polymeric polyol containing the terminal/pendent carbamate groups. Alternatively, carbamate functional groups can be incorporated into the polyurethane by reacting a polyisocyanate with a polyol and a hydroxyalkyl carbamate or isocyanic acid as separate reactants. Carbamate functional groups can also be incorporated into the polyurethane by reacting a hydroxyl functional polyurethane with a low molecular weight carbamate functional material via a transcarbamoylation process similar to the one described above in connection with the incorporation of carbamate groups into the acrylic polymer. Additionally, an isocyanate functional polyurethane can be reacted with a hydroxyalkyl carbamate to yield a carbamate functional polyurethane.

Other functional groups such as amide, thiol, urea, and thiocarbamate may be incorporated into the polyurethane as desired using suitably functional reactants if available, or conversion reactions as necessary to yield the desired functional groups. Such techniques are known to those skilled in the art.

As noted above, when the coating composition used in the process of the present invention is curable, it may further comprise a crosslinking agent. Suitable crosslinking materials include aminoplasts, polyisocyanates, polyacids, anhydrides and mixtures thereof. Useful aminoplast resins are based on the addition products of formaldehyde with an amino- or amido-group carrying substance. Condensation products obtained from the reaction of alcohols and formaldehyde with melamine, urea or benzoguanamine are most common and preferred herein. While the aldehyde employed is most often formaldehyde, other similar condensation products can be made from other aldehydes, such as acetaldehyde, crotonaldehyde, acrolein, benzaldehyde, furfural, glyoxal and the like.

Condensation products of other amines and amides can also be used, for example, aldehyde condensates of triazines, diazines, triazoles, guanadines, guanamines and alkyl- and aryl-substituted derivatives of such compounds, including alkyl- and aryl-substituted ureas and alkyl- and aryl-substituted melamines. Non-limiting examples of such compounds include N,N′-dimethyl urea, benzourea, dicyandiamide, formaguanamine, acetoguanamine, glycoluril, ammeline, 3,5-diaminotriazole, triaminopyrimidine, and 2-mercapto-4,6-diaminopyrimidine. The aminoplast resins often contain methylol or similar alkylol groups, and in most instances at least a portion of these alkylol groups are etherified by reaction with an alcohol. Any monohydric alcohol can be employed for this purpose, including methanol, ethanol, propanol, butanol, pentanol, hexanol, heptanol, as well as benzyl alcohol and other aromatic alcohols, cyclic alcohols such as cyclohexanol, monoethers of glycols, and halogen-substituted or other substituted alcohols such as 3-chloropropanol and butoxyethanol. Many aminoplast resins are partially alkylated with methanol or butanol.

Polyisocyanates that may be utilized as crosslinking agents can be prepared from a variety of isocyanate-containing materials. The polyisocyanate may be a blocked polyisocyanate. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used. Examples of suitable blocking agents include those materials which would unblock at elevated temperatures such as lower aliphatic alcohols including methanol, oximes such as methyl ethyl ketoxime, lactams such as caprolactam and pyrazoles such as dimethyl pyrazole.

Examples of polycarboxylic acids that are suitable for use as a crosslinking agent include those described in U.S. Pat. No. 4,681,811, at column 6, line 45 to column 9, line 54. Suitable polyanhydrides include those disclosed in U.S. Pat. No. 4,798,746, at column 10, lines 16-50, and in U.S. Pat. No. 4,732,790, at column 3, lines 41 to 57.

The coating compositions used in the process of the present invention may contain adjunct ingredients conventionally used in coating compositions. Optional ingredients such as, for example, plasticizers, surfactants, thixotropic agents, anti-gassing agents, organic cosolvents, flow controllers, anti-oxidants, UV light absorbers and similar additives conventional in the art may be included in the composition. These ingredients are typically present at up to about 40% by weight based on the total weight of resin solids.

The coating compositions may contain colorants conventionally used in surface coatings, rendering them translucent or opaque. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions, rendering the coating composition translucent or opaque. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,031 filed Jun. 24, 2004, which is incorporated herein by reference, and U.S. Provisional Application No. 60/482,167 filed Jun. 24, 2003, which is also incorporated herein by reference.

Example special effect compositions that may be used in the coating composition include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity, opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-lasting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 68 seconds. Example photochromic and/or photosensitive compositions include photochromic dyes.

In certain embodiments, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in the coating composition in any amount sufficient to impart the desired property, visual and/or color effect. The colorant may comprise from 1 to 65 weight percent of the present compositions, such as from 3 to 40 weight percent or 5 to 35 weight percent, with weight percent based on the total weight of the compositions.

Prior to applying the coating composition to the substrate in the process of the present invention, the coating composition is deposited on a carrier film, allowing the coating composition to be used as a transfer coating. The carrier film is typically formed from a flexible polymer and may comprise an acrylic polymer or any other suitable flexible polymer that can be formed into a film with sufficient structural integrity. After deposition on the carrier film, the coating composition may be flashed to dry to a tack-free surface, or even partially to substantially cured. A protective cover film intended to prevent damage during transport may be applied on the surface of the coating composition and removed just prior to application to the target substrate.

In certain embodiments, the carrier film is embossed with a texture such that after application of the coating composition to the target substrate and upon removal of the carrier film from the coating composition, the coating composition has a textured surface, providing a unique decorative finish to the applied transfer coating.

Examples of suitable carrier films are ULTRACAST release papers available from Sappi Warren Release Papers.

In the process of the present invention, the coating composition on the carrier film is contacted with the target substrate such that the coating composition is in direct contact with the target substrate. The substrate may be heated immediately prior to or during this contact step to enhance deposition of the coating composition onto the substrate. Additionally, pressure may be applied to the carrier film such as by rolling, to maximize contact of the coating composition with the substrate by removing trapped air pockets. After contacting the coating composition with the substrate, the carrier film may be removed. A curing step such as by heating may be done before or after removal of the carrier film.

The curable film-forming compositions used in the processes of the present invention are typically radiation curable or curable at elevated temperatures. A typical cure protocol is a temperature range from 50° F. (ambient) to 475° F. (10° C. to 248° F.) for 1 to 30 minutes.

Therefore, we claim:

1. A process for applying a coating composition to an exterior automotive substrate comprising:
(a) contacting the coating composition, which has been deposited on a carrier film, with the automotive substrate such that the coating composition is in direct contact with the automotive substrate; and
(b) removing the carrier film from the coating composition.

2. The process of claim 1, wherein the coating composition is opaque.

3. The process of claim 2, wherein the automotive substrate is a metal or plastic body part with a primer coating layer applied thereto, and wherein the coating composition is applied directly to the primer coating layer on the automotive substrate.

4. The process of claim 2, wherein the automotive substrate is a metal or plastic body part with a curable primer coating layer applied thereto and partially cured, and wherein the coating composition is a curable composition and is applied directly to the primer coating layer on the automotive substrate, and prior to or after removal of the carrier film in step (b), a curing step is performed wherein the automotive substrate is subjected to conditions sufficient to cure the primer coating layer and the coating composition.

5. The process of claim 4 wherein the primer coating layer comprises components having functional groups that are reactive with functional groups on components in the coating composition.

6. The process of claim 2, wherein the automotive substrate is a metal or plastic body part with an optional primer coating layer and a first pigmented base coat or monocoat layer having a first color applied thereto, and wherein the coating composition has a second, different color and is applied directly to the first pigmented base coat or monocoat layer.

7. The process of claim 1, wherein the coating composition is a curable composition and prior to or after removal of the carrier film in step (b), a curing step is performed wherein the automotive substrate is subjected to conditions sufficient to cure the coating composition.

8. The process of claim 1, wherein the carrier film is embossed with a texture such that upon removal of the carrier film from the coating composition, the coating composition has a textured surface.

9. The process of claim 1, wherein immediately prior to or during step (a), the automotive substrate is heated.

10. A process for applying a transfer coating to a substrate comprising:
(a) contacting the transfer coating, which has been deposited on a carrier film, with the substrate such that the transfer coating is in direct contact with the substrate; and
(b) removing the carrier film from the transfer coating;
wherein the transfer coating is opaque.

11. The process of claim 10, wherein the substrate comprises an exterior automotive substrate.

12. The process of claim 11, wherein the transfer coating comprises a pigmented monocoat or base coat.

13. The process of claim 10, wherein the substrate is metal or plastic with a primer coating layer applied thereto, and wherein the transfer coating is applied directly to the primer coating layer.

14. The process of claim 10, wherein the transfer coating is a curable composition and prior to or after removal of the carrier film in step (b), a curing step is performed wherein the substrate is subjected to conditions sufficient to cure the transfer coating.

15. The process of claim 10, wherein the substrate is metal or plastic with a primer coating layer applied thereto and partially cured, and wherein the transfer coating is a curable composition and is applied directly to the primer coating layer, and prior to or after removal of the carrier film in step (b), a curing step is performed wherein the substrate is subjected to conditions sufficient to cure the primer coating layer and the transfer coating.

16. A process for applying a two-tone, multi-component coating composition to a substrate comprising:
(a) optionally applying a primer coating layer to the substrate;
(b) applying a first pigmented base coat or monocoat layer having a first color to the primer coating layer or substrate;
(c) contacting with the substrate a transfer coating that has a second, different color and that has been deposited on a carrier film, such that the transfer coating is in direct contact with the first pigmented base coat or monocoat layer; and
(d) removing the carrier film from the transfer coating.

17. The process of claim 16, wherein the transfer coating is opaque.

18. The process of claim 16, wherein the substrate comprises an exterior automotive substrate.

19. The process of claim 18, wherein the automotive substrate is a body part and the first pigmented monocoat or basecoat applied thereto is partially cured prior to application of the transfer coating, and wherein the transfer coating is a curable composition and prior to or after removal of the carrier film in step (d), a curing step is performed wherein the automotive substrate is subjected to conditions sufficient to cure the first pigmented monocoat or basecoat and the transfer coating.

20. The process of claim 16, wherein the carrier film is embossed with a texture such that upon removal of the carrier film from the transfer coating, the transfer coating has a textured surface.
